(19) United States
(12) Patent Application Publication
(10) Pub. No.: US 2010/0193164 A1
(43) Pub. Date: Aug. 5, 2010

(54) OUTDOOR UNIT OF AIR CONDITIONER

(75) Inventor: Kazuhito WAKATSUKI, Fuji-Shi (JP)

Correspondence Address: DLA PIPER LLP US, P. O. BOX 2758, RESTON, VA, 20195, US

(73) Assignee: TOSHIBA CARRIER CORPORATION, Minato-Ku (JP)

(21) Appl. No.: 12/727,779

(22) Filed: Mar. 19, 2010

Related U.S. Application Data
(63) Continuation of application No. PCT/JP2008/067168, filed on Sep. 24, 2008.

(30) Foreign Application Priority Data
Sep. 28, 2007 (JP) 2007-254373

(51) Int. Cl. G06F 1/20

(52) U.S. Cl. 165/121

(57) ABSTRACT

The inside of an outdoor unit body is partitioned, by a partitioning wall, into a heat exchange chamber in which a heat exchanger and a blower are accommodated and a machine chamber in which a compressor and pipes are accommodated. An electronic component box is mounted between the outdoor unit body and the upper end of the partitioning wall. A control board is accommodated in the electronic component box in a horizontal posture so that a surface mounted with electronic components faces downward. An opening used for a lead wiring operation is opened in the bottom surface of the electronic component box. A wire cover is slidably attached to the bottom surface of the electronic component box to allow the opening for the lead wiring operation to freely open and close. According to this constitution, the electronic components can be prevented from falling to outside when electronic problems occur.

### CROSS REFERENCE TO RELATED APPLICATIONS

This is a Continuation Application of PCT Application No. PCT/JP2008/067168, filed Sep. 24, 2008, which was published under PCT Article 21(2) in Japanese.

This application is based upon and claims the benefit of priority from prior Japanese Patent Application No. 2007-254373, filed Sep. 28, 2007, the entire contents of which are incorporated herein by reference.

### BACKGROUND OF THE INVENTION

1. Field of the Invention

The present invention relates to an outdoor unit of an air conditioner including an electronic component box with an improved constitution.

2. Description of the Related Art

The inside of an outdoor unit body constituting an outdoor unit of an air conditioner is partitioned by a partitioning wall into a machine chamber and a heat exchange chamber. The machine chamber accommodates a compressor and pipes such as a four-way selector valve, and the heat exchange chamber accommodates a heat exchanger and an outdoor blower.

Outside air for cooling electrical components such as a compressor and a four-way selector valve is introduced in the machine chamber; however, in order to protect the electrical components from wind and rain infiltrated with the outside air, the machine chamber has a structure shielded to some extent from the outside air.

The electrical components such as the compressor, the four-way selector valve, and the outdoor blower are controlled and driven by electronic components such as a power transistor and a capacitor mounted on a control board. The control board and the electronic components are collectively accommodated in an electronic component box. The electronic component box is fitted into a cut-out portion provided at the upper end of the partitioning wall.

In the electronic component box, since the electronic components mounted on the control board and the electrical components such as the compressor are connected to each other through leads, the most of the electronic component box is disposed in the machine room. Thus, the outside air introduced into the machine chamber is partially taken into the machine chamber, whereby the temperature increase in the electronic components on the control board is regulated. Further, in order to efficiently cool heating electronic components such as a power transistor, radiating fins are protrusively provided in the heat exchange chamber and use air from the outdoor blower.

The outside air introduced into the machine chamber and the electronic component box contains dust, which is adhered to and deposited on the electronic components and the control board in the electronic component box, leading to the deterioration of the electronic components and contacts, whereby electronic problems may occur. Thus, in general techniques, the control board is mounted on the upper end of the inside of the electronic component box, and the electronic components are mounted thereon to face downward, whereby the adhesion and deposition of dust are minimized.

Further, Jpn. Pat. Appln. KOKAI Publication No. 2002-240277 discloses a technique for opening 50% or more of the bottom surface of the electronic component box facing the machine chamber. According to this technique, the connection between the electronic components accommodated in the electronic component box and the electrical components disposed in the outdoor unit body can be easily performed through the opening, whereby the electronic components are easily mounted.

### BRIEF SUMMARY OF THE INVENTION

Actually, of course, when a large opening is provided in the bottom surface of the electronic component box, a lead wiring operation for electrically connecting the electronic components mounted on the control board and the electrical components such as the compressor is facilitated. However, in Jpn. Pat. Appln. KOKAI Publication No. 2002-240277, the opening required for the wiring operation remains open after the completion of the wiring operation.

Namely, in the electronic component box, the opening for the lead wiring operation is opened in the machine chamber, and a large amount of the outside air for cooling the electrical components such as the compressor disposed in the machine chamber is introduced into the electronic component box through the opening. Since the outside air contains dust and moisture, the dust and moisture cause the electronic components and the contacts in the electronic component box to deteriorate with long-term use, whereby the occurrence of the electronic problems is inevitable.

The invention has been made in view of the above problems, and it is an object of the invention to provide an outdoor unit of an air conditioner. More specifically, a lead wiring operation for connecting electronic components accommodated in an electronic component box and electrical components disposed in an outdoor unit body is facilitated, contributing to improvement of workability, and, at the same time, an enclosing structure in which an opening of the electronic component box is closed after the completion of the lead wiring operation is provided, whereby the electronic components can be prevented from falling to outside when electronic problems occur.

In order to achieve the above object, in the outdoor unit of an air conditioner of the invention, the inside of the outdoor unit body including a case is partitioned by a partitioning wall into a heat exchange chamber in which a heat exchanger and a blower are accommodated and a machine chamber in which a compressor and pipes are accommodated, an electronic component box is mounted between the outdoor unit body and the upper end of the partitioning wall, a control board having a surface mounted with electronic components and facing downward is accommodated in the electronic component box in a horizontal posture, an opening for the lead wiring operation is opened in a portion of the bottom surface of the electronic component box, and a wire cover is slidably attached to the bottom surface of the electronic component box and freely opens and closes the opening for the lead wiring operation.

### BRIEF DESCRIPTION OF THE SEVERAL VIEWS OF THE DRAWING

FIG. 1 is an exploded perspective view of an outdoor unit of an air conditioner according to an embodiment of the invention.

FIG. 2 is an exploded perspective view of an electronic component box according to the embodiment.

FIG. 3A is a perspective view of the electronic component box when an opening is opened by a wire cover according to the embodiment.

FIG. 3B is a perspective view of the electronic component box when the opening is closed by the wire cover according to the embodiment.

FIG. 4A is a perspective view explaining a support state of electronic components in the partially omitted outdoor unit of an air conditioner according to the embodiment.

FIG. 4B is an enlarged perspective view of the electronic component box as the electronic components are viewed from a different direction in the partially omitted outdoor unit of an air conditioner according to the embodiment.

FIG. 5A is a bottom view of the electronic component box when the opening is opened by the wire cover according to the embodiment.

FIG. 5B is a bottom view of the electronic component box when the opening is closed by the wire cover according to the embodiment.

FIG. 6A is a perspective view of the electronic component box when the opening is opened by the wire cover according to the embodiment.

FIG. 6B is a perspective view of the electronic component box when the opening is closed by the wire cover according to the embodiment.

### DETAILED DESCRIPTION OF THE INVENTION

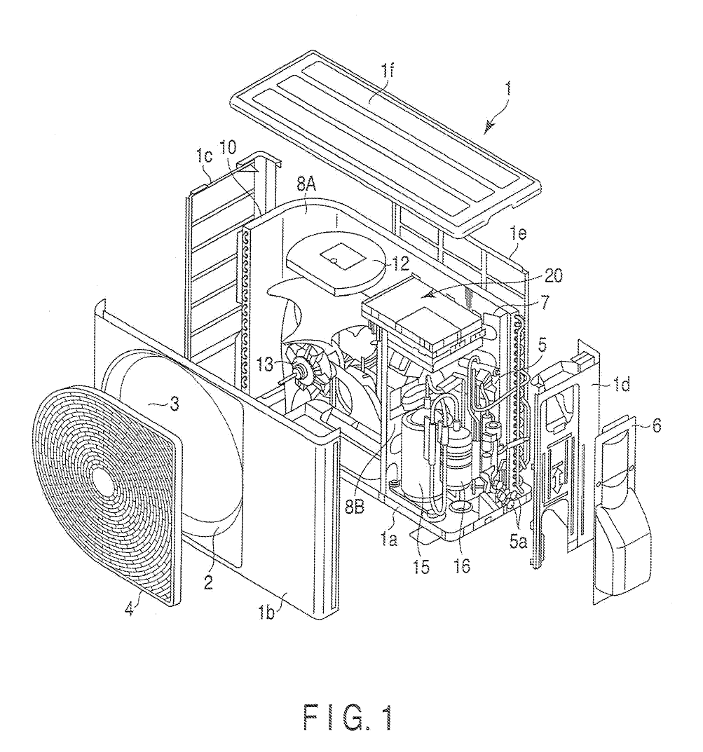

Hereinafter, embodiments of the present invention will be described with reference to the drawings. FIG. 1 is an exploded perspective view of an outdoor unit of an air conditioner. An outdoor unit body 1 including a case is constituted of a bottom plate 1a having an oblong rectangular shape in a planar view, a front cabinet 1b provided upright on the front surface side of the bottom plate 1a, a left-side cabinet 1c provided upright on the left side of the bottom plate 1a, a right-side cabinet 1d provided upright on the right side of the bottom plate 1a, a rear cabinet 1e provided upright on the rear surface side of the bottom plate 1a, and a top plate 1f provided over the upper ends of the front, left-side, right-side, and rear cabinets 1b, 1c, 1d, and 1e.

A blowing port 3 formed with a bell-mouth 2 is provided at a position closer to one side portion of the front cabinet 1b, and a fan guard 4 is fitted into the blowing port 3. The left-side cabinet 1c has crosspieces provided at a predetermined interval in up and down directions, and an opening is provided between these cross pieces.

The right-side cabinet 1d includes an opening through which pipes 5 to be described later are inserted and is covered by a packed valve cover 6. The pipes 5 include a four-way selector valve, a refrigerant pipe, and a packed valve 5a for use in connection with the refrigerant pipe extending from an indoor unit. The packed valve cover 6 is detached during connection of pipes and maintenance, whereby the operation can be easily performed.

The rear cabinet 1e has crosspieces provided at a predetermined interval in the longitudinal and lateral directions, and an opening is provided between the crosspieces. The top plate 1f includes one flat plate processed to be bent along the periphery and closes the top surface of the outdoor unit body 1. The inside of the outdoor unit body 1 having the above constitution is partitioned into two chambers by a partitioning wall 7.

The front end of the partitioning wall 7 is abutted against the rear surface of the side portion of the blowing port 3 of the front cabinet 1b, and the rear end is abutted against the intersecting corner portion of the rear cabinet 1e and the right-side cabinet 1d. The partitioning wall 7 extends from the front cabinet 1b in parallel with the left- and right-side cabinets 1c and 1d and is obliquely bent from the vicinity of the rear cabinet 1e toward the intersecting corner portion of the right-side cabinet 1d and the rear cabinet 1e.

Regarding the chambers obtained by partitioning by the partitioning wall 7, a space chamber on the side of the left-side cabinet 1c is a heat exchange chamber 8A, and a space chamber on the side of the right-side cabinet 1d is a machine chamber 8B. According to the mounting position and the configuration of the partitioning wall 7, the heat exchange chamber 8A has a capacity of about ¾ of the inside of the outdoor unit body 1, and the machine chamber 8B has a capacity of remaining about ¼ thereof.

In the heat exchange chamber 8A, a heat exchanger 10 is provided on the bottom plate 1a and disposed near the left-side cabinet 1c and the rear cabinet 1e. The heat exchanger 10 is formed into a substantially L shape in a planar view. One side end of the heat exchanger 10 is located at the intersecting corner portion of the front cabinet 1b and the left-side cabinet 1c, and the other side end is located at the intersecting corner portion of the right-side cabinet 1d and the rear cabinet 1e. The upper end of the heat exchanger 10 extremely approaches the top plate 1f.

Further, a blower support member 12 is provided in the heat exchange chamber 8A. The blower support member 12 supports an outdoor blower 13. Namely, the outdoor blower 13 is surrounded by the heat exchanger 10, the partitioning wall 7, and the front cabinet 1b. The outdoor blower 13 includes a propeller fan through which heat exchange air is drawn from the rear surface side in the axial direction and the air is blown to the front surface side.

Accompanying the blowing operation of the outdoor blower 13, outside air which is the heat exchange air is drawn through the left-side cabinet 1c and the rear cabinet 1e having an opening structure, and the outside air is blown out through the blowing port 3 of the front cabinet 1b provided to face the front surface side in the axial direction of the propeller fan. In this case, the bell-mouth 2 guides the outside air.

The blower support member 12 includes in its upper end a reinforcing member abutted against the front cabinet 1b and attached through a fixing member. The reinforcing member is formed by using a punched piece, which is obtained when the blowing port 3 is formed in the front cabinet 1b by punching, thereby contributing to effective use of materials.

A compressor 15 and a gas-liquid separator 16 are disposed in the machine chamber 8B, and the pipes 5 including a four-way selector valve and connected to the compressor 15 and the gas-liquid separator 16 are accommodated in the machine chamber 8B. The compressor 15 is connected to, for example, the heat exchanger 10 in the heat chamber 8A and a heat exchanger accommodated in an indoor unit through a refrigerant pipe so as to constitute a refrigeration cycle.

Since the overall height dimension of the compressor 15 and the gas-liquid separator 16 disposed in the machine chamber 8B and the pipes 5 connected to the compressor 15 is considerably smaller than the overall height dimension from the bottom plate 1a to the top plate 1f, a sufficient space can be secured. An electronic component box 20 is mounted in the space.

Namely, the upper end of the partitioning wall 7 is cut out, and the electronic component box 20 is fitted into the cut-out portion to be interposed and fixed between the bottom plate 1a and the top plate 1f. The electronic component box 20 has a thin box shape with small height and large length and width, and about ¾ thereof is located in the machine chamber 8B, and remaining about ¼ thereof projects into the heat exchange chamber 8A.

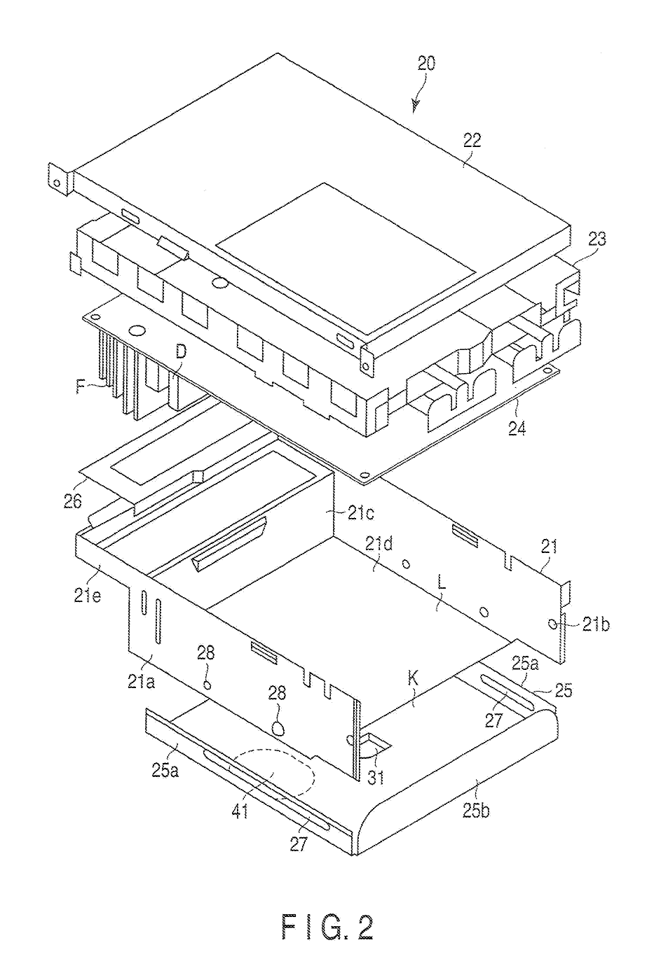

Next, the electronic component box 20 will be described in detail. FIG. 2 is an exploded perspective view of the electronic component box 20. The electronic component box 20 is constituted of an electronic component box body 21 and an electronic component box top plate 22. A control board base 23 is held between the electronic component box body 21 and the electronic component box top plate 22, and a control board 24 is attached to the control board base 23. A wire cover 25 is attached to the bottom surface of the electronic component box body 21.

The electronic component box top plate 22 is a metal plate-like member having a rectangular shape, and a bending portion is integrally formed in the lower portion of the electronic component box top plate 22 along the periphery. The control board base 23 is formed of resin and removably attached to the bending portion of the electronic component box top plate 22.

The control board 24 includes a printed circuit, and a control circuit such as a memory for storing a control program is formed on the lower surface in the drawing. Further, a plurality of connectors connected with, for example, an electrolytic capacitor, a power transistor, and a thermistor are mounted on the lower surface of the control board 24, and a wiring harness for, for example, an electrically-actuated valve and a four-way selector valve is connected to the control board 24.

Specifically, electronic components D are mounted on the lower surface of the control board 24 and control the compressor 15 in the machine chamber 8B and electrical components such as the four-way selector valve constituting the pipes 5 and the outdoor blower 13 in the machine chamber 8B. These electronic components D are in such a state of suspending from the lower surface of the control board 24. Radiating fins F for cooling heating components such as a power transistor of the electronic components D are attached to one side of the control board 24.

The electronic component box body 21 is made of metal, and a front plate 21a, a rear plate 21b, a left-side plate 21c, and a bottom plate 21d in which the right-side portion is missed to be opened, are integrally formed with the electronic component box body 21. The upper and right sides of the electronic component box body 21 are completely opened. A frame part 21e is protrusively provided at the upper end of the left-side plate 21c in a horizontal direction. The radiating fins F are inserted through the frame part 21e, and a seal member 26 seals between the frame part 21e and the radiating fins F.

The electronic components D mounted on the control board 24 are accommodated in a space surrounded by the front and rear plates 21a and 21b, the left-side plate 21c, and the bottom plate 21d substantially constituting the electronic component box body 21. Since an opening K is provided in the bottom plate 21d of the electronic component box body 21, the electronic components D mounted on the control board 24 are visible from the bottom surface side through the opening K.

The wire cover 25 is also made of metal and has on its front and rear sides bending pieces 25a which are in contact with the outer surface of the front and rear plates 21a and 21b of the electronic component box body 21. Each of the bending pieces 25a has a guide slit 27 provided along the longitudinal direction, and pins 28 protrusively provided on the front and rear plates 21a and 21b are inserted through the guide slits 27.

Thus, the wire cover 25 can freely slide with respect to the bottom plate 21d of the electronic component box body 21. More specifically, the wire cover 25 is attached onto the bottom plate of the electronic component box 20 in a slidable manner and can freely open and close the opening K formed in the bottom plate of the electronic component box 20.

Further, the wire cover 25 has on its right-side portion a closing piece 25b bending upward, and the closing piece 25b projects through the opening K formed in the bottom plate 21d. According to this constitution, the wire cover 25 is slidably biased, whereby the wire cover 25 can be displaced between a position of closing the opening K provided in the bottom plate 21d of the electronic component box body 21 and the position of opening the opening K.

Further, even when the wire cover 25 is located to close the opening K, the closing piece 25b provided in the wire cover 25 only partially closes an opening formed in the right-side portion of the electronic component box body 21, and thus the most of the opening is opened. As described later, the opening is a lead insertion opening L through which a lead wired to the electronic components D mounted on the control board 24 is inserted.

In the assembling of the outdoor unit of an air conditioner including the electronic component box 20 having the above constitution, the components such as the electronic component box 20, the heat exchanger 10, and the compressor 15 are disposed in and fixed to a predetermined position. The electronic component box 20 is mounted in the cut-out portion of the upper end of the partitioning wall 7 so that the radiating fins F and the periphery protrude into the heat exchange chamber 8A and most of the remaining portions face the machine chamber 8B.

Thereafter, a lead wiring operation is performed. In the lead wiring operation, the electronic components D in the electronic component box 20 and the electrical components such as the compressor 15 are electrically connected to each other.

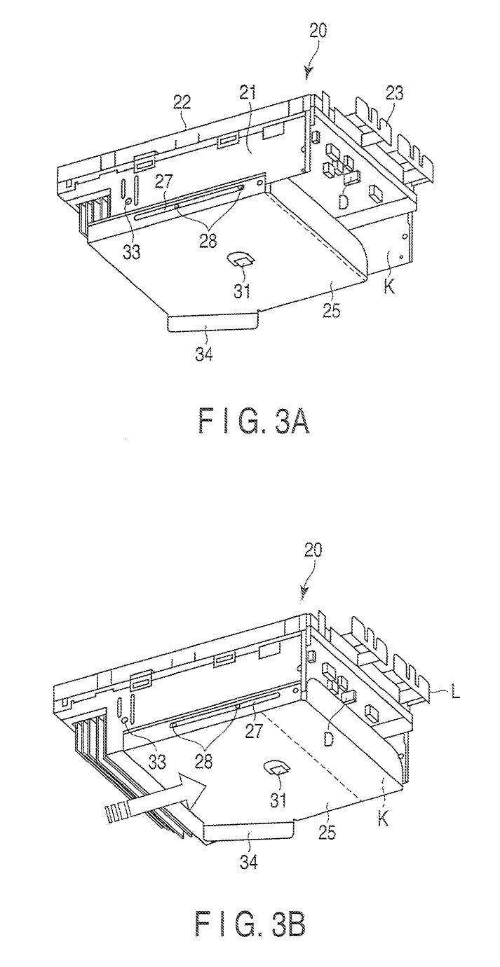

FIG. 3A is a perspective view of the electronic component box 20 in the lead wiring operation.

In the electronic component box 20, the wire cover 25 is slid to open the opening K formed in the bottom plate 21d of the electronic component box body 21. The lead on its one end is connected to the electrical components such as the compressor 15, and the other end is inserted in the electronic component box 20 through the opening K to be connected to the connector of the electronic components D mounted on the control board 24.

Alternatively, the wiring harness for, for example, an electrically-actuated valve and a four-way selector valve connected to the control board 24 is inserted in the machine chamber 8B through the opening K, and necessary connection is performed. The opening K formed in the bottom surface of the electronic component box 20 is used as the opening for the lead wiring operation, whereby the wiring workability can be improved.

FIG. 3B is a perspective view of the electronic component box 20 after the termination of the lead wiring operation.

After all the lead wiring operation is terminated, the wire cover 25 is slid to close the opening K in the bottom surface of the electronic component box 20. All leads are moved to be inserted through the lead insertion opening L opened in the right-side portion of the electronic component box 20, and the opening K is completely closed.

When a signal for start of an air conditioning operation (cooling operation) is input to the electronic components D and a control circuit in the electronic component box 20, the compressor 15 is driven and controlled, and a refrigeration cycle operation is performed. At the same time, the outdoor blower 13 is driven to draw outside air into the outdoor unit body 1 through the openings formed in the rear cabinet 1e and the left-side cabinet 1c, and thus, to circulate the outside air in the heat exchanger 10.

A refrigerant compressed by the compressor 15 is conducted to the heat exchanger 10 via the four-way selector valve and exchanges heat with the outside air. Thereafter, the refrigerant is guided into an indoor unit to be heat-exchanged with indoor air, and thus, to provide air conditioning (cooling).

The outside air exchanging heat with the heat exchanger 10 is guided into the bell-mouth 2 to be blown outside from the blowing port 3 via the fan guard 4. Since the radiating fins F provided in the electronic component box 20 project into the heat exchange chamber 8A, the radiating fins F radiate heat to the outside air accompanying the blowing operation of the outdoor blower 13, whereby heating electronic components such as a power transistor are cooled.

Further, the outside air is drawn into the machine chamber 8B accompanying the operation of the outdoor blower 13 to cool the compressor 15 and the gas-liquid separator 16 disposed in the machine chamber 8B, and thus, to be discharged outside. Since the most of the electronic component box 20 is disposed in the machine chamber 8B, the outside air drawn into the machine chamber 8B is partially introduced in the electronic component box 20, whereby the electronic components mounted in the electronic component box 20 are cooled.

As described above, the wire cover 25, which is a separately provided piece, is previously attached to the bottom surface of the electronic component box 20, and after the termination of the lead wiring operation, the wire cover 25 is slid to close the space for the lead wiring operation. Thus, the electronic component box 20 is constituted as a case with an enclosing structure, whereby the rigidity can be increased.

Even if the electronic components D in the electronic component box 20 are ruptured from any cause, or even if the circuit shorts to cause ignition, leading to peeling-off of the electronic components D from the control board 24 in the electronic component box 20, the electronic components D can be prevented from falling in the machine chamber 8B lower than the electronic component box 20. Namely, fire breaking due to ignition to, for example, a noise-proof material provided in the machine chamber 8B can be prevented, contributing to the improvement of safety.

In the above embodiment, while the electronic component box 20 is mounted between the cut-out portion of the partitioning wall 7 and the top plate 1f of the outdoor unit body 1, the opening K is opened, and the lead connection is performed. However, the invention is not limited to the above embodiment. Namely, when the electronic component box 20 is mounted in a predetermined position, the electronic components D including connectors are provided on the lower surface of the control board 24 in a horizontal posture.

When the lead, which on its one end is connected to the electrical components such as the compressor 15, is inserted into the electronic component box 20 through the opening K in the bottom surface of the electronic component box 20 to be connected to the connectors, an operator should operate while looking up at the electronic component box 20 and the control board 24. Since a plurality of leads are required to be connected, the operator continues the operation while looking upward, leading to the deterioration of workability.

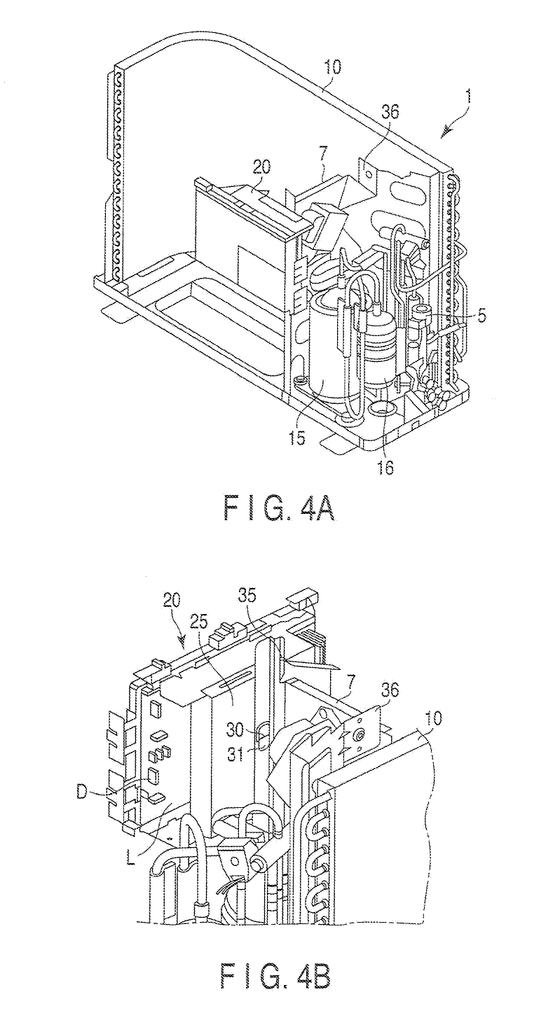

FIG. 4A is a perspective view of the electronic component box 20 in the lead wiring operation and the partially omitted outdoor unit body 1. FIG. 4B is an enlarged perspective view of the electronic component box 20 as viewed from the opposite side of FIG. 4A and the partially omitted outdoor unit body 1.

As shown in FIG. 4B, a hook 30 including a hole is provided in the front end portion of the partitioning wall 7 and separated to some extent from the upper end of the partitioning wall 7. The hook 30 is exposed from the front surface side of the outdoor unit body 1 by detaching the front cabinet 1b constituting the outdoor unit body 1.

Meanwhile, as shown in FIGS. 2, 3A, 3B, and 4B, a hooking claw 31 provided by cutting and raising is provided in a substantially central portion of the wire cover 25. The dimension in cutting and raising the hooking claw 31 is formed so as to be detachably hooked to the hook 30.

In the lead wiring operation, as shown in FIGS. 4A and 4B, the electronic component box 20 is turned to a vertical orientation, and the wire cover 25 of the bottom surface of the electronic component box 20 is brought into contact with the upper end of the partitioning wall 7. As shown in FIGS. 4B, the hooking claw 31 provided in the wire cover 25 is then hooked to the hook 30 provided in the front end of the partitioning wall 7.

In the above state, the entire electronic component box 20 projects from the front end of the partitioning wall 7 to the near side, and the form is changed to a vertically long box. The control board 24 accommodated in the electronic component box 20 is also in a vertical orientation. The lead insertion opening L also has a vertically long shape, and the wire cover 25 is slid to open the opening K in the bottom surface of the electronic component box 20.

Thus, the lead, which on its one end is connected to the electrical components such as the compressor 15, is inserted through the vertically long lead insertion opening L, which is opened in the side surface of the electronic component box 20, and connected to the connectors D on the vertically placed control board 24. The operator can operate by looking through the side of the electronic component box 20 without looking up at the control board 24, whereby the wiring workability can be improved.

As shown in FIG. 3B again, a screw hole 33 is provided in the side of the electronic component box body 21, and a position regulating piece 34 is provided at a corner of the wire cover 25. Further, as shown in FIG. 4B, a screw insertion hole 35 is provided in the partitioning wall 7, and, as shown in FIGS. 4A and 4B, a baffle plate 36 is preferably provided.

Namely, the invention has an object to increase the rigidity of the electronic component box 20 by providing the enclosing structure of closing the opening of the electronic component box 20 and to prevent the components from falling by closing the lower surface opening. Therefore, after the termination of the lead wiring operation, the wire cover 25 is required to be slid to a normal position to close the opening K in the bottom surface of the electronic component box 20.

Even when the wire cover 25 is provided, after the termination of the lead wiring operation, if the wire cover 25 does not close the opening K to leave the opening K open, or if the wire cover 25 operated to be slid is positioned at an intermediate position, and the opening K is not completely closed, the object of the invention cannot be achieved.

Thus, the screw hole 33 and the position regulating piece 34 are provided and, as described in FIGS. 4A and 4B, the electronic component box 20 is turned to a vertical orientation, and then the lead wiring operation is performed. After the termination of the lead wiring operation, the electronic component box 20 is turned to a horizontal orientation to be placed on the cut-out portion of the partitioning wall 7.

At this time, when the wire cover 25 is not slid to the normal position to completely close the opening K, the position regulating piece 34 provided in the wire cover 25 is in contact with the baffle plate 36 provided in the partitioning wall 7. The positions of the screw hole 33 of the electronic component box 20 and the screw insertion hole 35 of the partitioning wall 7 are deviated from each other, whereby a fixing screw cannot be inserted.

In other words, the position regulating piece 34 is provided in the wire cover 25, and the baffle plate 36 is provided in the partitioning wall 7, whereby the mounting position of the electronic component box 20 can be determined in such a state that the opening K for the lead wiring operation is completely closed.

In the above embodiment, the lead insertion opening L is provided in the side surface of the electronic component box 20; however, the invention is not limited thereto, and the lead may be taken out through the bottom surface of the electronic component box 20.

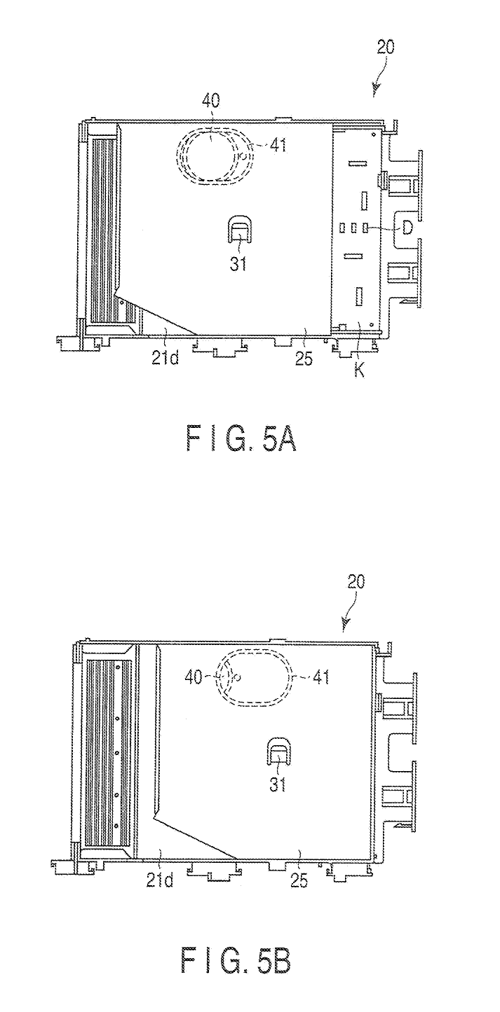

FIG. 5A is a bottom view of the electronic component box 20, and FIG. 5B is a bottom view of the electronic component box 20 in a different state from that of FIG. 5A.

Namely, in order to increase the rigidity of the electronic component box 20, it is preferable that an opening is not provided in the bottom surface of the electronic component box 20; however, an opening for taking out the leads may be provided according to conditions.

In this case, as shown by dashed lines in FIG. 5, a first wiring taking hole 40, which is a circular hole, is provided in the bottom plate 21d of the electronic component box body 21. Further, as shown by dashed lines in FIGS. 2 and 5, the wire cover 25 has a second wiring taking hole 41 which is a long hole. The distance from the side surface of the electronic component box 20 to the position of the axis of the first wiring taking hole 40 and the distance from the side surface of the electronic component box 20 to the position of the axis of the second wiring taking hole 41 coincide with each other, and their radii are the same.

As shown in FIG. 5A, in such a state that the opening K for the lead wiring operation provided in the bottom surface of the electronic component box 20 is opened by the wire cover 25, the position of the first wiring taking hole 40 and the position of the second wiring taking hole 41 substantially coincide, and they are communicated with each other. At this time, the first wiring taking hole 40 is completely opened. Even when necessary leads are inserted through the first wiring taking hole 40, a sufficient space can be secured.

As shown in FIG. 5B, in such a state that the opening K for the lead wiring operation of the electronic component box 20 is closed by the wire cover 25, the position of the first wiring taking hole 40 and the position of the second wiring taking hole 41 are deviated from each other, and they are closed remaining an opening. Namely, the first wiring taking hole 40 and the second wiring taking hole 41 remain partially opened, and the lead is inserted through the remaining opening in a state of being squeezed.

As described above, the wire cover 25 is provided on the bottom surface of the electronic component box 20, and the sliding structure of the wire cover 25 is used, whereby the first wiring taking hole 40 in the bottom plate 21d of the electronic component box body 21 and the second wiring taking hole 41 of the wire cover 25 are disposed to be deviated by [sliding mount]−[occupied cross-sectional area of a lead to be taken out].

In such a state that before the wire cover 25 is slid, the opening K is opened, the position of the first wiring taking hole 40 and the position of the second wiring taking hole 41 substantially coincide, and they are communicated with each other. The lead wiring operation can be performed while ensuring a satisfactory space for insertion of leads.

In such a state that after the wire cover 25 is slid, the opening K is closed, the position of the first wiring taking hole 40 and the position of the second wiring taking hole 41 are deviated from each other, and they are closed remaining an opening. Namely, since the area of the opening of the first and second wiring taking holes 40 and 41 can be restricted to the necessary minimum area capable of insertion of leads, the lower surface opening can be substantially closed.

In the lead wiring operation, the wire cover 25 is slid so as to open the opening K in the bottom surface of the electronic component box 20, and after the lead wiring operation, the wire cover 25 is slid to close the opening K. In any slide position, when the wire cover 25 is not reliably positioned in the normal position, workability will be affected.

Thus, means for positioning the wire cover 25 are provided respectively in the position of opening the opening K and the position of closing the opening K.

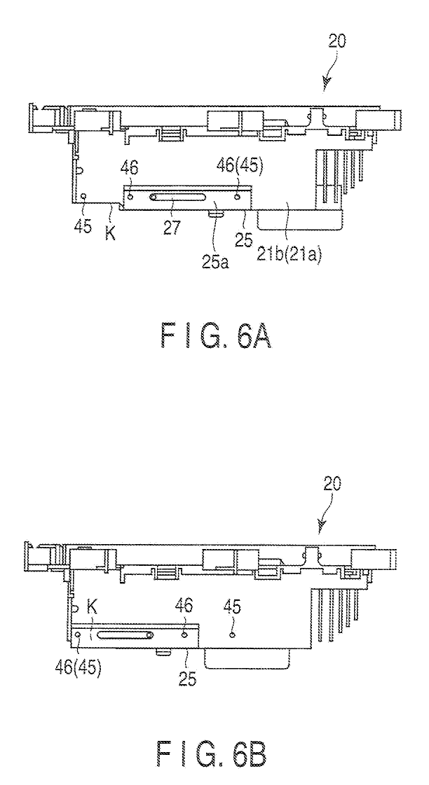

FIG. 6A is a side elevational view of the electronic component box 20 when the wire cover 25 is in the position of opening the opening K. FIG. 6B is a side elevational view of the electronic component box 20 when the wire cover 25 is in the position of closing the opening K.

A pair of protrusions 45, which are engaging parts, are provided on the left and right sides of the front and rear plates 21a and 21b of the electronic component box body 21 so as to be spaced from each other. Meanwhile, a pair of recesses 46, which are engaged parts, are provided in the left and right sides of the guide slit 27 of the bending piece 25a of the wire cover 25 so as to be spaced from each other. The protrusions 45 and the recesses 46 are formed to be freely engaged to each other.

In FIG. 6A, the wire cover 25 opens the opening K in the bottom surface of the electronic component box 20. The one recess 46 provided in the wire cover 25 is engaged to the one protrusion 45 (not shown) provided in the electronic component box body 21. Thus, the wire cover 25 for opening the opening K is positioned, and the position of the wire cover 25 is held unless the wire cover 25 is forcibly slidably biased.

In FIG. 6B, the wire cover 25 closes the opening K in the bottom surface of the electronic component box 20. The other recess 46 provided in the wire cover 25 is hooked to the other protrusion 45 (not shown) provided in the electronic component box body 21. Thus, the wire cover 25 for closing the opening K is positioned, and the position of the wire cover 25 is held unless the wire cover 25 is forcibly slidably biased.

The recesses 46 may be provided in the electronic component box body 21 instead of the protrusions 45, or the protrusions 45 may be provided in the wire cover 25 instead of the recesses 46. In any case, the engaging part 45 and the engaged part 46 for positioning the wire cover 25 are provided in the wire cover 25 and the electronic component box body 21, whereby the lead wiring operation is facilitated, and workability can be improved.

The invention is not limited to the above embodiments as such, and components can be modified and embodied without departing from the scope in an implementation stage. Various inventions can be formed by appropriate combinations of a plurality of components disclosed in the above embodiments.

According to the invention, the lead wiring operation is facilitated, whereby workability can be improved. The enclosing structure in which the opening of the electronic component box is closed after the termination of the lead wiring operation is provided, whereby the electronic components can be prevented from falling to outside when electronic problems occur.

What is claimed is:

1. An outdoor unit of an air conditioner, comprising:
an outdoor unit body which is a case partitioned in its inside, by a partitioning wall, into a heat exchange chamber in which a heat exchanger and a blower are accommodated and a machine chamber in which a compressor and pipes are accommodated;
an electronic component box which is interposed between a top plate of the outdoor unit body and a cut-out portion provided at an upper end of the partitioning wall;
a control board which is accommodated in the electronic component box in a horizontal posture and has a surface mounted with electronic components and facing downward;
an opening which is opened in a portion of a bottom surface of the electronic component box and used in a wiring operation for connecting leads to the electronic components; and
a wire cover which is slidably attached to the bottom surface of the electronic component box and freely opens and closes the opening for lead wiring operation.

2. The outdoor unit of an air conditioner according to claim 1, wherein the partitioning wall comprises a hook provided on the front surface of the outdoor unit body, and
the wire cover comprises a hooking claw, which hooks to the hook provided on the partitioning wall and keeps a vertical posture of the electronic component box body and the control board in the lead wiring operation to the electronic components.

3. The outdoor unit of an air conditioner according to claim 1, wherein a first wiring taking hole is provided in the bottom surface of the electronic component box body,
a second wiring taking hole is provided in the wire cover,
in a state that the opening for the lead wiring operation is opened by the wire cover, the position of the first wiring taking hole and the position of the second wiring taking hole substantially coincide, and the first and second wiring taking holes are communicated with each other, and
in a state that the opening for the lead wiring operation is closed by the wire cover, the position of the first wiring taking hole and the position of the second wiring taking hole are deviated from each other, and the first and second wiring taking holes are closed remaining an opening.

4. The outdoor unit of an air conditioner according to claim 1, wherein a pair of engaging parts and a pair of engaged parts, which are used for positioning of the wire cover at a position of opening the opening for the lead wiring operation by the wire cover and a position of closing the opening for the lead wiring operation by the wire cover, are provided in the electronic component box body and the wire cover.
